(19) United States
(12) Patent Application Publication
(10) Pub. No.: US 2017/0228616 A1
(43) Pub. Date: Aug. 10, 2017

(54) SYSTEMS AND METHODS FOR IMAGE CLASSIFICATION

(71) Applicants: Tolga Tasdizen, Salt Lake City, UT (US); Mojtaba Seyedhosseini, Sunnyvale, CA (US)

(72) Inventors: Tolga Tasdizen, Salt Lake City, UT (US); Mojtaba Seyedhosseini, Sunnyvale, CA (US)

(21) Appl. No.: 15/017,257

(22) Filed: Feb. 5, 2016

(51) Int. Cl. G06K 9/62; G06K 9/00

(52) U.S. Cl. CPC G06K 9/6256; G06K 9/6261; G06K 9/00624; G06K 9/6268

(57) ABSTRACT

An image classifier comprises a first classifier and a second classifier. The first classifier comprises L individual classifiers, which are trained at different, respective image resolutions from a first full-resolution level to a lowest-resolution level. Outputs of the first set of classifiers are used to train the second classifier at the full-resolution level. Accordingly, the second classifier exploits contextual information at multiple different image resolutions. The classifiers may be trained to optimize a joint posterior probability at multiple resolutions.

### CROSS-REFERENCE TO RELATED APPLICATIONS

The Application Data Sheet (“ADS”) filed in this application is incorporated by reference herein. Any applications claimed on the ADS for priority under 35 U.S.C. §§119, 120, 121, or 365(c), and any and all parent, grandparent, great-grandparent, etc., applications of such applications, are also incorporated by reference, including any priority claims made in those applications and any material incorporated by reference, to the extent such subject matter is not inconsistent herewith. This application claims the benefit of U.S. Provisional Patent Application No. 62/112,562 filed Feb. 5, 2015, which application is incorporated by reference to the extent such subject matter is not inconsistent herewith.

### TECHNICAL FIELD

This application relates to systems and methods for image processing and, in particular, to systems and methods for image classification using a contextual hierarchical model.

### BACKGROUND

Automated scene labeling is a core technology of many image processing applications, such as computer vision, automated diagnostics, and the like. Typically, scene labeling involves segmenting an image into regions corresponding to particular objects captured in the image. In a dataset of images of a particular object, such as horses for example, scene labeling may comprise labeling image pixels as either “object” (e.g., horse) or “background.” In more complex images, such as outdoor scenes comprising many different objects, scene labeling may comprise associating image regions with one of a plurality of different labels (e.g., building, car, person, sky, and so on). Scene labeling may also be used in lower-level image processing operations, such as edge detection, in which each image pixel is labeled as “edge” or “non-edge.”

Labeling a particular pixel in a scene typically involves some degree of image context. In most cases, individual image pixels cannot be accurately labeled based only on characteristics of the pixel itself and/or small image regions. For example, it may be difficult to distinguish a pixel belonging to the “sky” region of an image from a pixel within a “sea” region when considering only the pixel itself and/or a relatively small region around the pixel. Therefore, a scene labeling framework may incorporate contextual information of an image when classifying particular pixels. Although some approaches to scene labeling do incorporate image context, such approaches can be highly complex, involve extensive post-processing, and require the use of a priori contextual information, such as pre-segmentations, exemplars, shape fragments, object models, and/or the like. Therefore, what is needed are systems and methods for scene labeling based purely on input image patches (e.g., operate directly on image pixels, independent of a priori pre-segmentations, object models, exemplars and/or the like), and that do not require extensive post-processing (e.g., do not require searching a label space).

### BRIEF DESCRIPTION OF THE DRAWINGS

The disclosure references the following drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the scope of the subject matter presented herein.

FIG. 1 is a schematic block diagram of one embodiment of a system comprising a contextual hierarchical classifier;

FIG. 2 is a schematic system diagram of another embodiment of a system comprising a contextual hierarchical classifier;

FIG. 3A is a schematic block diagram of one embodiment of a computing device comprising a contextual hierarchical classifier;

FIG. 3B is a schematic block diagram of another embodiment of a computing device comprising a contextual hierarchical classifier;

FIG. 4A is a schematic block diagram of one embodiment of a contextual hierarchical classifier;

FIG. 4B is a schematic block diagram of another embodiment of a contextual hierarchical classifier;

FIG. 5 is a flow diagram of one embodiment of a method for training a contextual hierarchical classifier;

FIG. 6 is a flow diagram of one embodiment of a method for scene labeling by use of a contextual hierarchical classifier;

FIG. 7 is a flow diagram of another embodiment of a method for training a contextual hierarchical classifier; and

FIG. 8 is a flow diagram of another embodiment of a method for scene labeling by use of a contextual hierarchical classifier.

### DETAILED DESCRIPTION

Disclosed herein are embodiments of systems, apparatus, methods, and interfaces for scene labeling and, in particular, scene labeling image data by use of a contextual hierarchical model. As disclosed in further detail herein, use of the hierarchical contextual information limits complexity of image classification processing and does not require use of pre-segmentations or exemplars, such that image classification operations may be applied directly to image data. Moreover, classification outputs may not require extensive post-processing, such as searching within a label space.

In one embodiment, a contextual hierarchical classification (CHC) apparatus comprises a first classification circuit and a second classification circuit. The first classification circuit may be configured to train a first set of classifiers, and each classifier in the set may correspond to a different respective image resolution or scale. Accordingly, the first classification circuit may be referred to as a “multi-resolution classifier,” “hierarchical classifier,” and/or “bottom-up” classifier. The second classification circuit may incorporate multi-resolution outputs of the first classification circuit and, as such, may be referred to as a “contextual classifier” and/or “top-down classifier.”

Outputs of the first classification circuit (e.g., outputs of the respective classifiers in the first set) may be used by the second classification circuit for, inter alia, classifier training and/or image classification (e.g., scene labeling). The second classification circuit may be configured to operate on full-resolution input images. The second classification circuit may be further configured to leverage the multi-resolution contextual information generated by the classifiers of the first classification circuit, which may include a range of local to global contextual information.

In some embodiments, the first classification circuit trains the first set of classifiers in a supervised framework that incorporates simple filtering to create contextual images at different scales. The first classification circuit may be further configured to optimize a joint posterior probability of correct classification at respective image resolutions. Accordingly, the first set of classifiers may be referred to as “hierarchical” classifiers and/or “bottom-up” classifiers. Training a set of L hierarchical classifiers may comprise: a) generating images at a plurality of different resolutions, including an original resolution image X₁ to a lowest-resolution image X_{L}; and b) training L hierarchical classifiers corresponding to the respective image resolutions. Training a hierarchical classifier may comprise determining and/or refining classifier parameters Θ that optimize a probability of correctly labeling a training image. As used herein, a “training image” refers to image data for use in training an image classifier and, as such, may refer to an input image having an associated ground truth. As used herein, a “ground truth” refers to predetermined image labels. Accordingly, a “training image” refers to an image in comprising pre-classified and/or pre-labeled regions and/or pixels. A “classification image” refers to an image to be classified by one or more classifiers; as such, a classification image may not be associated with a ground truth (and/or the ground truth of the classification image may not be used by the CHC to label the image).

In one embodiment, the first set of classifiers operates in a supervised framework, such that outputs from higher-resolution classifiers (lower levels of the classifier hierarchy) are incorporated into lower-resolution classifiers (higher levels of the classifier hierarchy and/or vice versa). In one embodiment, the first classification circuit determines and/or refines classification parameters θₗ of the hierarchical classifier at level l of L levels as follows:

$$\hat{{θ}_{l}} = {arg max}_{{θ}_{l}} P ( Γ ( Y , l - 1 ) \vert Φ ( X , l - 1 ) , Γ ( {\hat{Y}}^{- 1} , l - 1 ) - Γ ( {\hat{Y}}^{l - 1} , 1 ) ; {θ}_{1} ) \qquad Eq . 1$$

In Eq. 1, Θₗ are internal classifier parameters for the hierarchical classifier at resolution level l given input images X, Y are classification outputs for image X of other higher-resolution classifiers in the hierarchy (e.g., classifiers 1 through l-1), Φ is an image downscaling operator (e.g., average pixel value in two by two window), and Γ is a max-pooling downscaling operator (e.g., maximum pixel value in each two by two window). Accordingly, classifiers at higher levels within the hierarchy have access to contextual information from larger areas because they are trained on lower-resolution, downscaled images (e.g., the classifier L may operate on input image data corresponding to L-1 downscaling operations and/or downscaled L-1 times a downscaling factor). The hierarchical classifier at the first level of the hierarchy, however, may be trained without contextual information of lower-resolution classifiers.

Outputs Y^{l} of the hierarchical classifiers may be configured to incorporate classification outputs of other classifiers in the first set of classifiers. In one embodiment, the lth classifier is configured to incorporate classification outputs of all lower-level classifiers (e.g., Y¹ through Y^{l-1}). The first set of classifiers may, therefore, incorporate supervised, multi-resolution contextual information at various levels within the hierarchy. Labeling an input image at level l of the first classification circuit may comprise the following inference operation:

$${\hat{Y}}^{l} = {arg max}_{Y} P ( Y \vert Φ ( X , l - 1 ) , Γ ( {\hat{Y}}^{- 1} , l - 1 ) - Γ ( {\hat{Y}}^{l - 1} , 1 ) ; \hat{{θ}_{1}} ) \qquad Eq . 2$$

In Eq. 2, Y^{l} is a classification output of the lth hierarchical classifier. Accordingly, as illustrated in Eq. 2, the first set of classifiers incorporate supervised, multi-resolution contextual information, wherein the lth level classifier incorporates outputs of l-1 lower-level classifiers within the first set of classifiers (e.g., outputs Y^{l-1} through Y^{I}). The first-level hierarchical classifier may operate directly on the input image, without contextual information from larger image areas.

The second classification circuit may incorporate outputs of the first classification circuit, and, in particular, may incorporate outputs of each classifier in the first set of classifiers (e.g., output at each level of the hierarchy). Accordingly, the second classifier of the second classification circuit may be referred to as a “top-down” classifier. Parameters β of the top-down classifier may be determined and/or refined as follows:

$$\hat{β} = {arg max}_{β} P ( Y \vert X , \hat{{Y}^{1}} , Ω ( {\hat{Y}}^{2} , 1 ) - Ω ( {\hat{Y}}^{L} , L - 1 ) ; β ) \qquad Eq . 3$$

In Eq. 3, Ω(•, 1) is an up-sampling operator that upscales lower-resolution training images to higher-resolution training images (e.g., by pixel duplication).

Similarly, classification outputs Z of the top-down classifier may incorporate classification outputs of the hierarchical classifiers, as follows:

$$\hat{Z} = {arg max}_{Y} P ( Y \vert X , {\hat{Y}}^{1} , Ω ( {\hat{Y}}^{2} , 1 ) - Ω ( {\hat{Y}}^{L} , L - 1 ) ; \hat{β} ) \qquad Eq . 4$$

As illustrated in Eq. 4, the classification output Z of the top-down classifier may incorporate classification outputs Y¹-Y^{L} of the first classification circuit, and may be calculated independently of pre-segmentation information, exemplars, object models, and/or the like. Accordingly, the CHC apparatus may implement classification training and/or scene labeling operations directly on image data, independent of a priori contextual information, such as pre-segmentations, exemplars, shape fragments, object models, and/or the like. Moreover, the intermediate classification outputs Y¹-Y^{L} and/or classification output Z may comprise scene labels and, as such, may not require additional search operations within a label space.

In one embodiment, the CHC apparatus is configured to train the first set of hierarchical classifiers and/or second top-down classifier by: a) accessing a set of training images X with corresponding ground truth metadata (e.g., predetermined scene labels) and, for each input image, b) learning parameters \hat{θ}₁ of the first-level hierarchical classifier based on image features and/or without contextual information; c) determining classification outputs of the first-level hierarchical classifier Ŷ¹; d) iteratively training L-1 hierarchical classifiers (e.g., learn \hat{θ}ₗ and/or determine classification outputs Ŷ^{l} for lower levels of the hierarchy, as disclosed above); and e) learning parameters \hat{β} the top-down classifier of the second classification circuit (e.g., by use of the classification outputs Y¹-Y^{L} of the first classification circuit).

The CHC apparatus may be further configured to label an input image X by use of trained classifiers of the first and/or second classification circuits, which may comprise a) determining outputs Y¹-Y^{L} for the input image X corresponding to each of the bottom-up hierarchical classifiers of the first classification circuit; and b) determining a classification output of the CHC by use of the second top-down classifier of the second classification circuit (e.g., output Z of Eq. 4).

Disclosed herein are embodiments of an apparatus for image classification. The apparatus may include an image classifier comprising a bottom-up classification circuit and a top-down classification circuit. The bottom-up classification circuit may be configured to train L hierarchical classifiers, wherein each of the L hierarchical classifiers corresponds to a respective image resolution level, the L hierarchical classifiers comprising a highest-resolution classifier and one or more lower-resolution classifiers. The bottom-up classification circuit may be configured to determine parameters of the highest-resolution classifier by use of a training image, and to determine parameters of the one or more lower-resolution classifiers based on downscaled versions of the training image and classification outputs of one or more higher-resolution classifiers. The top-down classification circuit may be configured to train a top-down classifier by use of the full-resolution training image and classification outputs corresponding to each of the L classifiers of the bottom-up classification circuit. The image classifier may be configured to classify an input image by use of the L classifiers of the bottom-up classification circuit and the top-down classifier of the top-down classification circuit. The apparatus may further include a scene labeling module to annotate the input image in accordance with a classification output of the top-down classification circuit. In some embodiments, the apparatus comprises an image manipulation module to derive a labeled image in response to the input image, wherein the labeled image comprises one or more regions of the input image corresponding to one or more classification labels of a classification output of the top-down classification circuit.

Training a lower-resolution hierarchical classifier l of the L hierarchical classifiers may comprise producing a downscaled version of the training image, generating downscaled classification outputs corresponding to classification outputs of hierarchical classifier l-1, and learning parameters of the lower-resolution classifier l by use of the downscaled version of the training image and the downscaled classification outputs. The bottom-up classification circuit may be configured to calculate the parameters of the lower-resolution classifier l to maximize a probability of classifying the downscaled version of the training image in accordance with the downscaled classification outputs. The bottom-up training circuit may be configured to determine parameters \hat{θ}ₗ of the classifier l in accordance with Eq. 1, as disclosed above. The image classifier circuit may be configured to determine classification outputs Ŷ of the respective L hierarchical classifiers in accordance with Eq. 2, as disclosed above. The top-down training circuit may be configured to determine parameters \hat{β} of the top-down classifier in accordance with Eq. 3, and to determine classification outputs \hat{Z} in accordance with Eq. 4, as disclosed above.

Disclosed herein are embodiments of a system for image classification. The disclosed system may comprise an image classification device comprising a first classification module that trains L resolution-specific classifiers by use of a set of training images, the L bottom-up classifiers comprising a first, full image resolution bottom-up classifier and bottom-up classifiers 2 through L corresponding to lower image resolutions. Training the first bottom-up classifier may comprise learning classifier parameters using the set of training images. Training bottom-up classifier l of bottom-up classifiers 2 through L on a training image X of the set of training images comprises determining classifier parameters \hat{θ}ₗ of the bottom-up classifier l by use of Eq. 1, as disclosed above. The image classification device may further comprise a second classification module that determines parameters \hat{β} of a composite-resolution classifier by use of the set of training images and classification outputs Ŷ of the L resolution-specific classifiers by use of Eq. 3, as disclosed above. In some embodiments, the system further comprises a display module that displays label annotations on a display device corresponding to classification outputs for an input image generated by use of the L resolution-specific classifiers and the composite-resolution classifier. The composite-resolution classifier infers classification outputs \hat{Z} of the input image Q by use of classification outputs of the L bottom-up classifiers Ŷ and the parameters \hat{β} by use of Eq. 4, as disclosed above.

Embodiments of the system disclosed herein may include an image transformation module that applies classification labels to the input image in accordance with the classification output \hat{Z}. The L resolution-specific classifiers may comprise logistic disjunctive normal network classifiers. The system may further include a post-classification policy that defines one or more post-classification processing operations to implement in response to an input image comprising a region associated with a particular label.

Disclosed herein are embodiments of a method for image classification. The disclosed method may include training a plurality of intermediate classifiers, each intermediate classifier corresponding to a respective image resolution, wherein training the intermediate classifiers comprises, training a high-resolution intermediate classifier by use of a training image, and training one or more lower-resolution intermediate classifiers by use of lower-resolution versions of the training image and outputs of one or more higher-resolution intermediate classifiers. The method may further comprise training a multi-resolution image classifier by use of classification outputs of the plurality of intermediate classifiers, transforming an input image by labeling regions of the input image according to classification outputs of the multi-resolution image classifier and the plurality of intermediate classifiers. Transforming the input image may comprise annotating a region of the input image that is associated with a particular classification label. Alternatively, or in addition, transforming the input image comprises graphically depicting labeled regions of the input image on a display device in accordance with the classification outputs of the multi-resolution image classifier. In some embodiments, training the high-resolution intermediate classifier comprises calculating parameters for the high-resolution intermediate classifier that maximize a probability of labeling regions of the training image in accordance with predetermined labels of the training image. Training a lower-resolution intermediate classifier may comprise calculating parameters for the lower-resolution intermediate classifier that maximize a probability of labeling regions of a lower-resolution version of the training image in accordance with a classification output of the high-resolution intermediate classifier. Training the multi-resolution classifier may comprise determining classifier parameters that maximize a probability of correct classification of the training image in accordance with classification outputs of the plurality of intermediate classifiers.

Training the plurality of intermediate classifiers may comprise determining parameters [symbol] of a first intermediate classifier using the training image X having predetermined labels Y; and calculating parameters \hat{θ}ₗ of intermediate classifiers at l resolution levels by:

$$\hat{{θ}_{l}} = {arg max}_{{θ}_{l}} P ( Γ ( Y , l - 1 ) \vert Φ ( X , l - 1 ) , Γ ( {\hat{Y}}^{1} , l - 1 ) - Γ ( {\hat{Y}}^{l - 1} , 1 ) ; {θ}_{l} )$$

In the disclosed method, Γ and Φ may correspond to downscaling operators, and Ŷ are outputs of respective intermediate classifiers. The method may further include calculating parameters \hat{β} of the multi-resolution classifier by use of classification outputs of the first intermediate classifier, and the l lower-resolution classifiers by:

$$\hat{β} = {arg max}_{β} P ( Y \vert X , \hat{{Y}^{1}} , Ω ( {\hat{Y}}^{2} , 1 ) - Ω ( \hat{{Y}^{L}} , L - 1 ) ; β ) ,$$

In the disclosed method, Ω may correspond to an up-sampling operator.

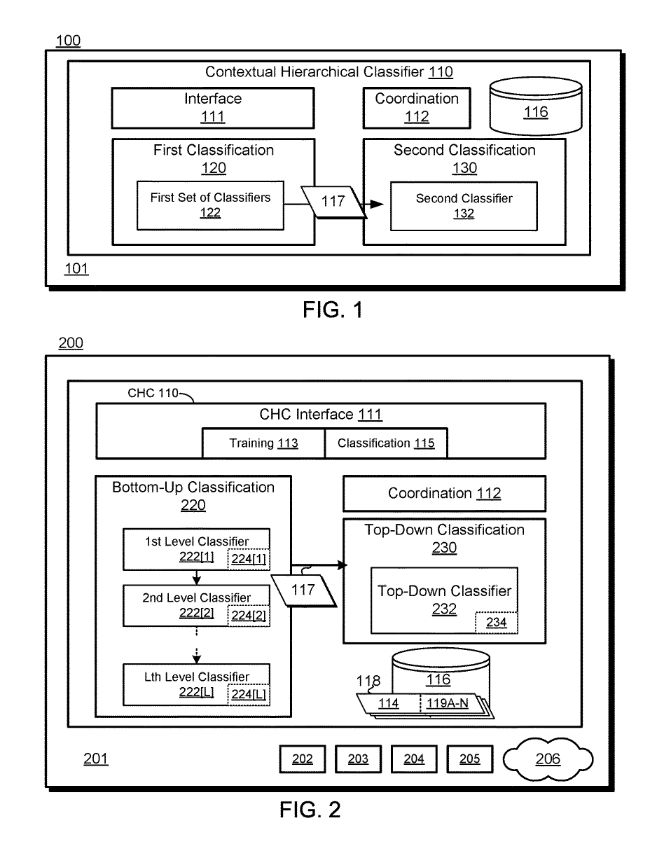

FIG. 1 is a schematic block diagram of one embodiment of a system 100 comprising a contextual hierarchical classifier (CHC) 110. In some embodiments, the CHC 110 comprises a special-purpose computing system 101 comprising a first classification circuit 120 and a second classification circuit 130. The first classification circuit 120 and/or second classification circuit 130 may comprise one or more of a) an application-specific integrated circuit (ASIC), a field-programmable gate array (FPGA), a programmable logic array (PLG), and/or the like. Alternatively, or in addition, the first classification circuit 120 and/or second classification circuit 130 may comprise general-purpose computing resources, such as a general-purpose processor, volatile memory resources, non-transitory storage resources, communication interfaces, human-machine interface components (e.g., input/output devices, display devices), and the like.

The first classification circuit 120 may be configured to train a first set of classifiers 122 and/or determine classification outputs of the first set of classifiers 122, as disclosed herein. The first set of classifiers 122 may include a plurality of classifiers configured to operate on images having a particular resolution and/or scale. In some embodiments, the first set of classifiers 122 includes a set of L classifiers in a classifier hierarchy. The classifier hierarchy may include a classifier configured to operate on full-resolution images (e.g., a classifier at the first level of the hierarchy) and one or more classifiers configured to operate on lower-resolution image data (e.g., a lowest-resolution Lth classifier in the hierarchy). Accordingly, the first classification circuit 120 may be configured to determine a first set of classifier parameters, including classifier parameters Θ_{1 -L}, wherein classifier parameters Θ₁ correspond to a highest-resolution classifier, and classifier parameters Θ_{L} correspond to a lowest-resolution classifier in the first set of classifiers 122.

The first classification circuit 120 may be configured to learn the classifier parameters Θ_{1-L} by use of a training data set, comprising one or more training images and corresponding ground truths (e.g., predetermined scene labels), as disclosed herein. In some embodiments, the first classification circuit 120 is configured to learn classifier parameters Θ_{1-L} in accordance with Eq. 1, disclosed above. Accordingly, training the first set of classifiers 122 may comprise supervising classifier training in a classifier hierarchy, such that classifiers at higher levels within the hierarchy (operating on lower-resolution images) incorporate outputs of classifiers at lower levels within the hierarchy (operating on higher-resolution images).

The first classification circuit 120 may be further configured to label input images using the first set of classifiers 122 (and the corresponding learned classifier parameters Θ_{1-L}). As disclosed herein, “labeling” an image may comprise determining a classification output for the image in which classification labels are applied to particular regions and/or pixels of the image. Accordingly, labeling an image may comprise applying classification labels to respective image pixels, generating a classification and/or label mask corresponding to the image, and/or the like. The first classification circuit 120 may be configured to determine classification outputs in accordance with Eq. 2, as disclosed herein. Accordingly, determining a classification output corresponding to an input image may comprise supervising a classifier hierarchy, such that outputs of classifiers at higher levels within the hierarchy (operating on lower-resolution image) incorporate outputs generated by classifiers at lower levels within the hierarchy (operating on higher-resolution image data).

The first classification circuit 120 may be configured to generate a contextual classification output metadata (CCO) metadata 117 in response to an input image, such as a training image and/or classification image. The CCO metadata 117 may include classification outputs of one or more of the first set of classifiers 122. In some embodiments, the CCO metadata 117 includes a classification output of each of the classifiers in the first set of classifiers 122. Accordingly, the CCO metadata 117 may include classification outputs Y¹-Y^{L} corresponding to each of L classifiers in the first set of classifiers 122. Each of the classification outputs Y¹-Y^{L} may be associated with a different respective image resolution, as disclosed herein (e.g., the classification output Y¹ may correspond to an output of a full-resolution classifier, and the output Y^{L} may correspond to an output of a lowest-resolution classifier in the first set of classifiers 122). The CCO metadata 117 may further include image data used to generate the respective classification outputs and/or an indication of a resolution and/or hierarchy level corresponding to each of the classification outputs.

The second classification circuit 130 may comprise a second classifier 132. The second classifier 132 may be configured to incorporate the CCO metadata 117 generated by the first classification circuit 120 to determine parameters β of the second classifier 132 and/or determine an image classification output of the second classifier 132. The second classifier 132 may comprise a top-down classifier, as disclosed herein. The second classification circuit 130 may be configured to train the second classifier 132 (e.g., learn parameters β) in accordance with Eq. 3, as disclosed herein. Accordingly, training the second classifier 132 may comprise incorporating classification outputs corresponding to a plurality of different image resolutions to maximize a joint posterior probability of correctly classifying the training image. The second classification circuit 130 may be configured to generate classification output for the second classifier 132 in accordance with Eq. 4, as disclosed herein. Accordingly, classification outputs Z of the second classifier may take advantage of prior information of multiple resolutions, including both local and global contextual information developed in the supervised framework of the first classification circuit 120.

In some embodiments, the CHC 110 further comprises and/or is communicatively coupled to classification metadata storage 116. The classification metadata storage 116 may comprise a non-transitory storage resource, such as a disk, network attached storage, non-volatile memory, and/or the like. The CHC 110 may use the classification metadata storage 116 to persist data pertaining to the CHC 110, including, but not limited to: training data sets (e.g., training images and/or corresponding ground truths), learned classifier parameters Θ_{1-L} and/or β of Eqs. 1-4 above, image classification metadata (e.g., image labels), outputs of the classifiers (e.g., classification outputs of the first set of classifiers 122, classification outputs of the second classifier 132, CCO metadata 117, image data (at various resolutions and/or scales), and so on). In some embodiments, the classification metadata storage 116 comprises a plurality of different classifier parameters Θ_{1-L}, β and/or label sets corresponding to particular image types and/or image classification applications.

The CHC 110 of FIG. 1 may further comprise a coordination module 112 to manage operation of the first classification circuit 120 and/or second classification circuit 130. In some embodiments, the coordination module 112 a) manages data flow within the CHC 110 and/or b) manages training and/or classification operations of the first classification circuit 120 and second classification circuit 130. The coordination module 112 may be configured to provide CCO metadata 117 generated by the first classification circuit 120 to the second classification circuit 130. The coordination module 112 may be further configured to schedule training and/or classification operations, to ensure that CCO metadata 117 required by the second classification 130 is available when needed. In some embodiments, the coordination module 112 stalls the second classification module 130 while the first classification module 120 generates CCO metadata 117. Alternatively, or in addition, the coordination module 112 may stagger, buffer, and/or pipeline outputs of the first classification module 120, such that while the second classification module 130 implements training and/or classification operations using CCO metadata 117 of a first image, the first classification module 120 generates CCO metadata 117 for a second image.

The coordination module may be further configured to manage and/or schedule operations within the first classification circuit 120. As disclosed herein, lower-resolution classifiers of the first set of classifiers 122 may incorporate outputs of higher-resolution classifiers, such that classification outputs flow up the classifier hierarchy from low levels of the hierarchy (e.g., first-level classifier operating on full-resolution input images) to higher levels of the hierarchy (e.g., lth-level classifiers operating on lower-resolution input images). In some embodiments, the coordination module 112 schedules training and/or classification operations of the respective classifiers 122 to ensure that classification outputs required for particular classification operations are available when needed, which may comprise stalling one or more of the classifiers 122. Alternatively, or in addition, the coordination module 112 may be configured to stagger, buffer, and/or pipeline outputs of the first set of classifiers, such that while the classifier at level two of the hierarchy generates a classification output pertaining to a first image (using an output generated by the classifier at level one), the classifier at level one generates a classification output pertaining to a second image, and so on.

The CHC 110 may further comprise a CHC interface 111 configured to provide access to image classification functionality implemented by the CHC 110, such as classifier training, image classification, and/or the like. The CHC interface 111 may be implemented and/or presented by use of various components, modules, circuits, and/or the like, including, but not limited to: a kernel-level module, a user-space module, a driver-level module, a driver, an I/O controller, an I/O manager, an I/O layer, an I/O service, a library, a shared library, a loadable library, a dynamic-link library (DLL) library, a device driver, a device driver interface (DDI) module, a logical device driver (LDD) module, a physical device driver (PDD) module, a windows driver foundation (WFD) module, a user-mode driver framework (UMDF) module, a kernel-mode driver framework (KMDF) module, an I/O Kit module, a uniform driver interface (UDI) module, a software development kit (SDK), and/or the like.

The CHC interface 111 may expose primitives for a) training the classifier(s) of the CHC 110, including the first set of classifiers 122 of the first classification circuit 120 and/or the second classifier 132 of the second classification circuit 130, by use of one or more training images and corresponding labels, and/or b) classifying an input image using the trained classifiers. The CHC interface 111 may further provide for specifying training data (e.g., input images and/or corresponding ground truths), specify a set of image labels, and so on. In some embodiments, the CHC interface 111 is configured to provide for selection of a particular set of classifier parameters Θ_{1-L} and/or β and/or image classification labels for use in one or more image classification operations. The classifier parameters Θ_{1-L} and/or β and/or image classification labels may be maintained on classification metadata storage 116 of the CHC 110, may be passed through the CHC interface 111, and/or accessed from another storage location.

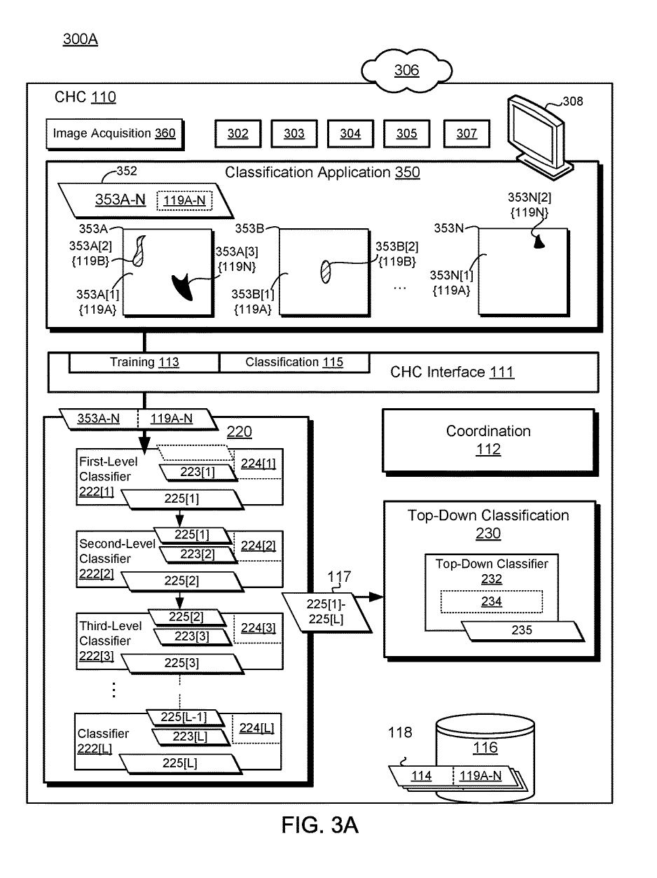

FIG. 2 is a schematic system diagram of another embodiment of a system 200 comprising a CHC 110. In the FIG. 2 embodiment, the CHC 110 may be embodied on a computing system 201. The computing system 201 may comprise one or more computing devices, including, but not limited to: an imaging system, a medical diagnosis system, a server, a desktop, a laptop, an embedded system, a mobile device, a storage device, a network-attached storage device, a storage appliance, a plurality of computing devices (e.g., a cluster), and/or the like. The computing system 201 may comprise processing resources 202, memory resources 203 (e.g., volatile random access memory (RAM)), non-transitory storage resources 204, and/or a communication interface 205. The processing resources 202 may include, but are not limited to: general-purpose central processing units (CPUs), ASICs, programmable logic elements, FPGAs, programmable logic arrays (PLGs), graphical processing (GPU) resources, single instruction multiple data (SIMD) processing resources, and/or the like. The communication interface 205 may be configured to communicatively couple the computing system 201 to a network 206. The network 206 may comprise any suitable communication network, including, but not limited to: a Transmission Control Protocol/Internet Protocol (TCP/IP) network, a Local Area Network (LAN), a Wide Area Network (WAN), a Virtual Private Network (VPN), a Storage Area Network (SAN), and/or the like.

The CHC 110 may comprise a first classifier and a second classifier, as disclosed herein. In the FIG. 2 embodiment, the first classifier may comprise a bottom-up classification module 220, and the second classifier may comprise a top-down classification module 230. The CHC 110 and/or the modules, components, elements, and/or functionality thereof, including the bottom-up classification module 220 and/or the top-down classification module 230, may be embodied as software, hardware, and/or a combination of software and hardware elements. In some embodiments, portions of the CHC 110 (and/or modules thereof) comprise machine-executable instructions stored on a non-transitory, machine-readable storage medium, such as the storage resources 204 of the computing system 201. The instructions may comprise computer program code that, when executed by a computing device (e.g., processing resources 202), cause the computing device to implement processing steps, procedures, and/or operations, as disclosed herein. The CHC 110, and/or modules thereof, may be implemented and/or embodied as a driver, a library, an interface, an API, an FPGA configuration, firmware (e.g., stored on an Electrically Erasable Programmable Read-Only Memory (EEPROM)), and/or the like. Accordingly, portions of the CHC 110 may be accessed by and/or included within other modules, processes, and/or services (e.g., incorporated within a kernel and/or an application layer of an operating system of the computing system 101). In some embodiments, portions of the CHC 110 are embodied as hardware and/or machine components, which may include, but are not limited to: circuits, integrated circuits, processing components, interface components, hardware controller(s), general-purpose processing resources, configurable logic element(s), programmable hardware, FPGAs, ASICs, and/or the like.

The bottom-up classification module 220 may comprise a set of L classifiers 222[1]-222[L], each corresponding to a respective level of an image resolution hierarchy. The first-level classifier 222[1] within the hierarchy may be configured to process full-resolution images, the second level classifier 222[2] within the hierarchy may be configured to process lower-resolution images (e.g., downscaled image data), and so on. The Lth classifier 222[L] may be configured to process lowest-resolution images within the hierarchy. The top-down classification module 230 may comprise a top-down classifier 232 configured to incorporate hierarchical, contextual image classification outputs (e.g., CCO metadata 117) produced by the bottom-up classification module 220, as disclosed herein. As disclosed in further detail herein, classification outputs 225[1]-225[L] of the classifiers 222[1]-222[L] may be used to train the top-down classifier 232 and/or generate classification outputs 235 of the top-down classifier 232. Accordingly, the classifiers 222[1]-222[L] may be referred to as “intermediate” classifiers 222[1]-222[L] , “resolution-specific” classifiers 222[1]-222[L], “hierarchical” classifiers 222[1]-222[L], and/or the like. The top-down classifier 232 may incorporate classification information pertaining to a plurality of different image resolutions and/or resolution levels (as generated by the bottom-up classification module 220). Accordingly, the top-down classifier 232 may be referred to as a “composite-resolution” classifier 232, a multi-resolution classifier 232, and/or the like.

The classifiers 122, 132, 222[1]-222[L] and/or 232 disclosed herein may comprise any suitable classifier and/or classification technique and may include, but are not limited to: artificial neural network (ANN) classifiers, support vector machine (SVM) classifiers, random forest (RF) classifiers, logistic disjunctive normal network (LDNN) classifiers, and/or the like. In the FIG. 2 embodiment, the classifiers 222[1]-222[L] and 232 comprise LDNN classifiers comprising an adaptive layer implemented by use of logistic sigmoid functions, followed by two fixed layers of logical units that compute conjunctions and disjunctions, respectively. The LDNN classifiers 222[1]-222[L] and/or 232 may provide for intuitive initialization using k-means clustering, resulting in relatively fast training times, suitable for use with the CHC 110, disclosed herein.

The CHC interface 111 may be configured to provide access to image classification functionality of the CHC 110, as disclosed herein. In the FIG. 2 embodiment, the CHC interface 111 comprises a training interface 113 and a classification interface 115. The training interface 113 may be configured to provide for training the CHC 110. The training interface 113 may be configured to receive training data, comprising training images and/or corresponding ground truths, and/or configure the bottom-up classification module 220 and/or top-down classification module 230 to learn classifier parameters using the received training data (e.g., learn classifier parameters Θ_{1-L} and/or β, as disclosed herein). The training interface 113 may be further configured to manage storage of learned classifier parameters on the storage resources 204 of the computing system 201 (and/or other storage location), load classifier parameters pertaining to a particular image classification application from the storage resources 204 (and/or other storage location), and/or the like.

The bottom-up classification module 220 may be configured to train the classifiers 222[1]-222[L], as disclosed above (e.g., in accordance with Eq. 1 above). In response to a training image, the first-level classifier 222[1] may be configured to learn classification parameters 224[1] by use of the full-resolution training image (and/or without classification outputs of other classifiers of the bottom-up classification module 220). Classification outputs of the first-level classifier 222[1] may be incorporated by the second-level classifier 222[2] to learn classification parameters 224[1] on a lower-resolution training image. Classification outputs of the second-level classifier 222[2] may be incorporated by other lower-resolution classifiers, as disclosed herein (including the Lth classifier 222[L] comprising parameters 224[L]).

The top-down classification module 230 may learn classification parameters 234 of the top-down classifier 232 by use of: a) full-resolution training image(s), and b) CCO metadata 117 generated by the bottom-up classification module 220. As disclosed above, the CCO metadata 117 may comprise classification outputs of each of the classifiers 222[1]-222[L] of the bottom-up classification module 220 (e.g., classification outputs corresponding to each level of L resolution levels). In one embodiment, the top-down classification module 230 trains the top-down classifier 232 in accordance with Eq. 3, as disclosed herein.

The coordination module 112 may be configured to manage training operations of the bottom-up classification module 220 and/or top-down classification module 230 by, inter alia, scheduling and/or buffering training outputs (e.g., outputs of particular hierarchical classifiers 222[1] . . . 222[L], CCO metadata 117, and so on), such that training operations of the bottom-up classification module 220 and/or the top-down classification module 230 are performed in response to availability of classification outputs required by the respective training operations.

The coordination module 112 may be further configured to manage the classification metadata storage 116 and, in particular, manage CHC classification metadata 118. As used herein, CHC classification metadata 118 includes, but is not limited to, CHC parameters 114 and corresponding scene labels 119A-N. The CHC parameters 114 may comprise a set of classifier parameters, such as parameters 224[1] . . . 224[L] of the bottom-up classification module 220 and/or parameters 234 of the top-down classification module 230. The CHC labels 119A-N may comprise image labels associated with a particular scene labeling application (e.g., labels 119A-N corresponding to the ground truths of the training images used to learn the CHC parameters 114). In some embodiments, the CHC classification metadata 118 comprises a plurality of different sets of CHC classification metadata 118, each corresponding to a respective image type and/or image classification application. The CHC classification metadata 118 may, for example, include CHC parameters 114 and labels 119A-N corresponding to a medical imaging application pertaining to a particular type of Computerized Tomography (CT) images. Alternatively, or in addition, the CHC classification metadata 118 may further comprise a separate, different set of CHC parameters 114 and labels 119A-N of a different imaging application (e.g., ultrasound image diagnostics), and so on. The coordination module 112 may be configured to learn, refine, update, and/or persist CHC classification metadata 118 in response to training data provided through the training interface 113, as disclosed herein.

The CHC interface 111 may further comprise classification interface 115 configured to provide access to image classification functionality of the CHC 110. The classification interface 115 may be configured to a) receive an input image to be classified by the CHC 110, b) specify CHC classification metadata 118 for use in labeling the input image (e.g., classifier parameters 114A-N and/or labels 119A-N), c) specify an output format for the classification operation, and so on. The classification interface 115 may be further configured to access data of the input image by use of one or more of: Direct Memory Access (DMA); Remote DMA (RDMA); storage resources 204 of the computing system 201; remote storage resources (accessible through the network 206); and/or the like. The classification interface 115 may be further configured to provide the input image data to the bottom-up classification module 220 and/or top-down classification module 230 by use of, inter alia, the coordination module 112.

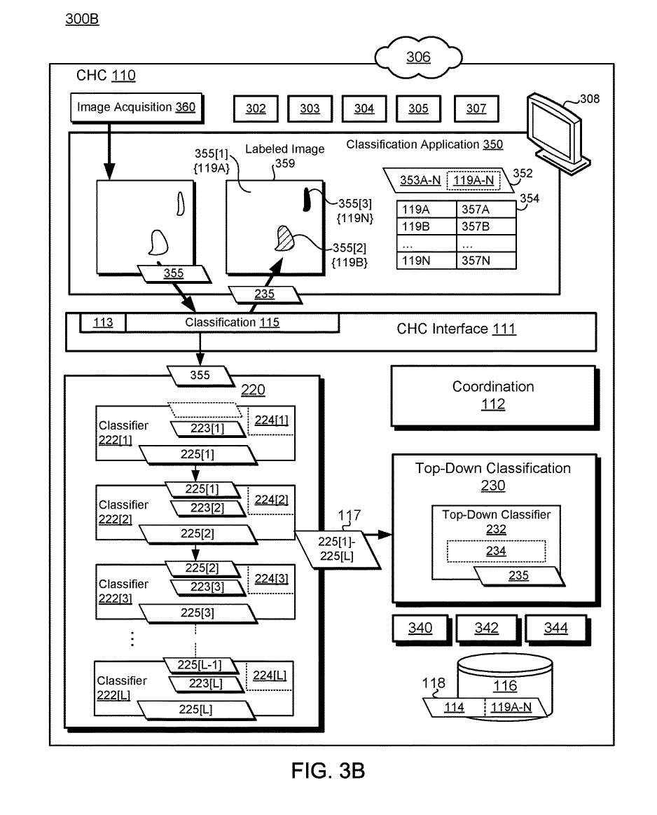

FIG. 3A is a schematic block diagram of a system 300A comprising a CHC 110, as disclosed herein. The CHC 110 of FIG. 3A may comprise a special-purpose computing device comprising processing resources 302, volatile memory resources 303, non-transitory storage resources 304, a communication interface 305 communicatively coupled to a network 306, human-machine interface (HMI) devices 307, a display device 308, and so on. The processing resources 302 may comprise special-purpose processing elements, including, but not limited to: an ASIC, a configurable logic circuit, an FPGA, a co-processor, a SIMD processor, and/or the like. Accordingly, the CHC 110, bottom-up classification module 220, and/or top-down classification module 230 may comprise respective hardware elements (e.g., may comprise respective circuits as in FIG. 1). Alternatively, or in addition, the processing resources 302 may comprise general-purpose processing resources, such as a general-purpose processor, a virtual processor (of a virtualized computing environment), and/or the like. The memory resources 303 may comprise volatile RAM, virtual memory resources, and/or the like. The non-transitory storage resources 304 may comprise persistent memory storage, such as disk storage resources, solid-state storage resources, network storage resources, and/or the like. Accordingly, in some embodiments, the CHC 110, the bottom-up classification module 220, and/or top-down classification module 230 may embody general-purpose computing elements and/or may be embodied as machine-readable instructions stored on the storage resources 304, as disclosed herein.

The HMI devices 307 may include input/output devices, which may include, but are not limited to: a keyboard input device, a pointer input device, a mouse, an audio input device (e.g., microphone), a touch input device (e.g., touch-sensitive display devices), a gesture input device, and/or the like. The display device 308 may comprise a graphical display device, such as a monitor, holographic display, imaging device, and/or the like.

In the FIG. 3A embodiment, the CHC 110 comprises a classification application 350. The classification application 350 may be configured to manage scene labeling operations for particular image types and/or as part of a higher-level application, such as medical imaging and/or diagnosis. Accordingly, the CHC 110 of FIG. 3A may comprise a special-purpose computing device adapted to implement specific embodiments of the classification operations, disclosed herein. The classification application 350 may be configured to access classification functionality of the CHC 110 through the CHC interface 111 and/or through direct communication with the coordination module 112, bottom-up classification module 220 and/or top-down classification module 230. Although FIG. 3A depicts the classification application 350 as a module of the CHC 110, the disclosure is not limited in this regard and may be adapted to include a classification application 350 implemented as an application and/or a computing device separate from the CHC 110. The classification application 350 of the FIG. 3A embodiment may comprise training data 352 that includes a set of training images 353A-N. The training images 353A-N may comprise respective ground truths. Accordingly, regions and/or pixels of the training images 353A-N may be associated with image classification labels 119A-N, a priori. In the FIG. 3A embodiment, the ground truth of training image 353A associates region 353A[1] with a background label 119A, associates region 353A[2] with label 119B, and associates region 353A[3] with label 119N; region 353B[1] of training image 353B is associated with the background label 119A and region 353B[2] is tagged with label 119B; and training image 353N comprises a background region 353N[1] (associated with label 119A) and region 353N[2] (associated with label 119N).

In some embodiments, the system 300A further comprises and/or is communicatively coupled to an image acquisition system 360. The image acquisition system 360 may include, but is not limited to: a camera, an infra-red camera, an electro-optical (EO) radiation imaging system, a CT image acquisition system (e.g., a CT scanning device), an ultrasound image acquisition system, an X-ray image acquisition system, a nuclear imaging system, such as a position emission tomography (PET) imaging system, a single photon emission computed tomography (SPECT) imaging system, and/or the like. In some embodiments, the classification application 350 is configured to a) acquire image data from and/or by use of the image acquisition system 360 and b) classify regions of the acquired image data by use of the CHC 110.

The classification application 350 may train the CHC 110 to perform particular image classification operations by use of a training data 352. The training data 352 may comprise training images 353A-N and corresponding ground truths (e.g., scene labels 119A-N). The training images 353A-N may be acquired by use of the image acquisition system 360 and/or another imaging system. The training images 353A-N may comprise regions of interest to a particular image processing application. In one embodiment, the training images 353A-N comprise neuropil structures (e.g., brain imagery). The training images 353A-N may be pre-labeled with anatomical areas of interest, such as membranes, cell boundaries, background, and/or the like. In another embodiment, the training images 353A-N comprise skin photographs for automated Melanoma evaluation. The training images 353A-N may comprise labels identifying areas in the training images 353A-N that are indicative of melanoma, and areas that are background (normal skin) and/or benign skin features (e.g., moles, etc.). In another embodiment, the training images 353A-N comprise radiological images comprising labels to identify particular anatomical structures, anomalies (e.g., tumors), background regions, and/or the like. The training images 353A-N may be labeled by an expert (e.g., by use of the HMI devices 307 and/or display device 308). Alternatively, the training images 353A-N may be accessed from an image repository and/or other external source.

The classification application 350 may be configured to train the CHC 110 by use of the training data 352. Training the CHC 110 may comprise submitting the training images 353A-N (with the corresponding ground truth labels 119A-N) to the CHC 110, by use of the training interface 113. In response to the training images 353A-N, the CHC 110 may develop CHC classification metadata 118. The CHC classification metadata 118 may comprise parameters 114 of the bottom-up classification module 220 (classifier parameters 224[1]-224[L]) and/or top-down classification module 230 (classifier parameters 234), as disclosed herein. In response to a training image 353A-N, the CHC 110 may be configured to: a) learn classifier parameters 224[1] . . . 224[L] by use of the bottom-up classification module 220, b) generate classification outputs 225[1] . . . 225[L] by use of the bottom-up classification module 220, c) provide CCO metadata 117 to the top-down classification module 230 (including respective classification outputs 225[1] . . . 225[L]), d) learn parameters 234 of the top-down classifier 232, and/or e) update the CHC classification metadata 118 (e.g., persist and/or update parameters 224[1]-224[L] and 234 of the CHC classification metadata 118).

In the FIG. 3A embodiment, bottom-up classification module 220 comprises a first-level classifier 222[1]. The first-level classifier 222[1] may be configured to classify full-resolution input image data 223[1]. Accordingly, the input image data 223[1] of the first-level classifier 222[1] may comprise full-resolution versions of the respective training images 353A-N. The parameters 224[1] of the first-level classifier 222[1] may be learned by use of the training images 353A-N (denoted as 223[1] in FIG. 3A) and corresponding ground truths (e.g., predetermined labels 119A-N applied to the training images 353A-N). In one embodiment, the bottom-up classification module 220 learns parameters 224[1] of the first-level classifier 222[1] in accordance with Eq. 1, as disclosed herein (e.g., learns parameters Θ₁). Training the first-level classifier 222[1] may further include generating a classification output 225[1]. The classification output 225[1] may be interfered in accordance with Eq. 2, as disclosed herein. The first-level classification output 225[1] may comprise scene labeling metadata (output labels 119A-N) applied to the image data 223[1] by use of the learned parameters 224[1], in accordance with Eq. 2 as disclosed herein (e.g., classification output Y¹).

The second-level classifier 222[2] may be configured to process lower-resolution image data 223[2], which may comprise downscaled versions of the training images 353A-N. The downscaled training images 353A-N of the second-level classifier 222[2] are denoted as 223[2] in FIG. 3A. The parameters 224[2] of the second-level classifier 222[2] may be learned by use of classification outputs 225[1] of the first-level classifier 222[1] and downscaled image data 223[2], in accordance with Eq. 1 as disclosed above (e.g., learn parameters Θ₂ by use of outputs Y¹ and lower-resolution image data 223[2]). A classification output 225[2] of the second-level classifier 222[2] may be generated by use of the learned parameters 224[2] (e.g., in accordance with Eq. 2). The parameters 224[3] of the third-level classifier 222[3] may be learned by use of further downscaled image data 223[3], outputs of upper-level classifiers (e.g., classification outputs 225[2] and/or 225[1]), and so on. The Lth-level classifier 222[L] may learn parameters 224[L] by use of classification outputs 225[1]-225[L-1] of upper-level classifiers 222[1]-222[L-1], and lowest-resolution image data 223[L] (e.g., a training images 353A-N downscaled L-1 times).

The bottom-up classification module 220 may be further configured to generate CCO metadata 117 in response to the training images 353A-N. As disclosed above, CCO metadata 117 may include classification outputs 225[1]-225[N] of the respective classifiers 222[1]-222[L]. The CCO metadata 117 may further include and/or identify the training images 353A-N (and/or downscaled versions thereof) 223[1]-223 [L] used to produce the classification outputs 225[1]-225[L].

Training the top-down classification module 230 may comprise accessing CCO metadata 117 generated by the bottom-up classification module 220 to learn parameters 234 of the top-down classifier 232. The top-down classification module 230 may be configured to learn classifier parameters 234 based on, inter alia, a full-resolution training images 353A-N (and corresponding ground truth labels 119A-N) and classification outputs 225[1]-225[L] of the hierarchical classifiers 222[1]-222[L] of the bottom-up classification module 220, as disclosed herein. The top-down classifier 232 may be configured to optimize a joint posterior at multiple resolutions (e.g., resolutions corresponding to the classifiers 222[1]-222[L]). In some embodiments, the top-down classification module 230 is configured to learn classifier parameters β in accordance with Eq. 3. The top-down classifier 232 may be further configured to generate a classification output 235 in response to input images. In some embodiments, the top-down classifier 232 infers classification outputs 235 in accordance with Eq. 4, as disclosed herein.

The coordination module 112 may be configured to manage data flow between the training interface 113, bottom-up classification module 220, and/or top-down classification module 230. The coordination module 112 may be configured to access training image data (e.g., training images 353A-N), provide the training images 353A-N to the bottom-up classification module 220, provide training images 353A-N and/or CCO metadata 117 to the top-down classification 230, and so on as disclosed herein. The coordination module 112 may be further configured to schedule training operations of the bottom-up classification module 220 and/or top-down classification module 230 in accordance with the availability of training images 353A-N, CCO metadata 117 (e.g., classification outputs 225[1]-225[L]), and so on. The coordination module 112 may be further configured to maintain CHC classification metadata 118 by use of the classification metadata storage 116. As disclosed above, the CHC classification metadata 118 may comprise parameters 114 of the bottom-up classification module 220 (e.g., parameters 224[1]-224[L]) and the top-down classification module 230 (e.g., parameters 234) learned by use of the training images 353A-N. The CHC classification metadata 118 may further include the label namespace of the training images 353A-N (and/or the labels 119A-N may be inferred from the classifier parameters 114).

FIG. 3B is a schematic block diagram of another embodiment of a system 300B for image classification. In the FIG. 3B embodiment, the classification application 350 has trained the CHC 110 to implement a particular image classification operation, which, as disclosed above, may comprise learning classifier parameters 114 for the bottom-up classification module 220 and/or top-down classification module 230 and/or corresponding labels 119A-N. The classifier parameters 114 and/or labels 119A-N may be persisted as CHC classification metadata 118.

The classification application 350 of FIG. 3B may be configured to implement an image classification application pertaining to a specific image type and/or imaging application. In the FIG. 3B embodiment, the classification application 350 (and CHC 110) implements a medical diagnosis imaging application to identify anatomical anomalies in radiological images (input images 355), such as tumors in a particular anatomical area. The input images 355 may be acquired by use of an image acquisition system 360, as disclosed herein. The classification application 350 may comprise and/or define a label namespace to denote regions of interest within the input images 355. The labels 119A-N may include a label 119A indicative of background features (e.g., features unrelated to anatomical anomalies), a label 119B indicating a particular type of anomaly (e.g., a benign tumor), a label 119N indicating another type of anomaly (e.g., a malignant tumor), and so on. The classification application 350 may be configured to train the CHC 110 to classify input images with the labels 119A-N by use of training data 352, as disclosed herein. The training data 352 may comprise one or more training images 353A-N and corresponding ground truths (e.g., predetermined image labels 119A-N), which may be used to determine CHC classification metadata 118 of the CHC 110, including classifier parameters 224[1]-224[L] of the bottom-up classification module 220 and classifier parameters 234 of the top-down classification module 230.

The classification application 350 may further include a post-classification policy 354 that, inter alia, defines post-classification operations 357A-N to perform in response to detecting regions associated with particular labels 119A-N. In the FIG. 3B embodiment, the post-classification policy 354 may be configured for a particular medical diagnosis application (e.g., to process images pertaining to anatomical anomalies, as disclosed above). The post-classification policy 354 may, therefore, be configured to define post-classification operations 357A-N to perform in response to detecting input images 355 comprising particular anatomical anomalies (e.g., in response to input images 355 comprising regions associated with particular labels 119A-N). The post-classification operations 357A-N may include any suitable processing operation including, but not limited to: archiving an input image 355 and/or classification outputs 235 (by use of storage resources 304), transmitting an input image 355 and/or classification outputs 235 (by use of the communication interface 305 and/or network 306), generating classification metadata, such as a labeled image 359, displaying the input image 355 and/or classification outputs 235 on the display device 308, issuing one or more notifications and/or alerts pertaining to the input image 355 and/or classification outputs 235, and/or the like. In one embodiment, the post-classification policy 354 designates post-processing operations 357A for images labeled exclusively as background 119A, which may comprise archiving the input image 355 and corresponding classification outputs 235. The post-classification policy 354 may further specify post-classification operations 357B pertaining to input images 355 comprising regions assigned label 119B (e.g., benign tumor), which may include annotating the input image 355 for further analysis (e.g., generating, displaying, and/or archiving a labeled image 359). The post-classification policy 354 may further specify post-classification operations 357N pertaining to input images 355 comprising regions assigned label 119N, which may be indicative of a potentially serious condition, such as a malignant tumor. The post-classification operations 357N may comprise marking the input image 355 for immediate analysis, issuing notification(s) and/or alerts to particular practitioners, issuing notification(s) and/or alerts to other automated systems, and/or the like. Although specific embodiments of a post-classification policy 354 and post-classification operations 357A-N for a particular image classification application 350 are described herein, the disclosure is not limited in this regard and could be adapted to implement any suitable post-classification operations 357A-N defined in any suitable post-classification policy 354.

The classification application 350 may access scene labeling functionality of the CHC 110 through the classification interface 115, as disclosed herein. Classifying an input image 355 may comprise a) providing the input image 355 to the CHC 110, and/or b) specifying CHC classification metadata 118 for use in classifying the input image 355. In response to an input image 355, the CHC 110 may a) configure the classifiers 222[1]-222[L] of the bottom-up classification module 220 and/or top-down classifier 232 of the top-down classification module 230 by use of the CHC classification metadata 118, b) generate CCO metadata 117 by use of the bottom-up classification module 220, and c) generate a classification output 235 by use of top-down classification module 230 (and CCO metadata 117 generated by the bottom-up classification module 220).

In the FIG. 3B embodiment, the bottom-up classification module 220 comprises L hierarchical classifiers 222[1], including a first-level classifier 222[1] configured to classify full-resolution image data 223[1] (e.g., full-resolution version of the input image 355). The input image data 223[1] of the first-level classifier 222[1] may, therefore, comprise a full-resolution version of the input image 355. The first-level classifier 222[1] may be configured to generate a classification output 225[1] by use of the full-resolution input image data 223[1] and the classifier parameters 224[1]. In one embodiment, the classification output 225[1] of the first-level classifier 222[1] is generated in accordance with Eq. 2, as disclosed herein.

Hierarchical classifiers 222[2]-222[L] may be configured to classify lower-resolution versions of the input image 355. Classification outputs 225[2]-225[L] of the hierarchical classifiers may be based on downscaled versions of the input image 355 and classification outputs 225[1]-225[L] of lower-level classifiers within the classifier hierarchy (e.g., other classifiers 222[1]-222[L-1]). In some embodiments, the hierarchical classifiers 222[2]-222[L] infer respective classification outputs 225[2]-225[L] in accordance with Eq. 2, as disclosed herein. The top-down classification module 230 is configured to generate the classification output 235 of the CHC 110 by use of the input image 355, the classification outputs 225[1]-225[L] of the bottom-up classification module 220 (and corresponding down-sampled image data 223[2]-223[L] as provided in the CCO metadata 117), and the top-down classifier parameters 234. In some embodiments, the top-down classification module 230 infers the classification output 235 of the top-down classifier 232 in accordance with Eq. 4, as disclosed herein. The classification output 235 may associate regions and/or pixels of the input image 355 with respective labels 119A-N. Accordingly, the classification output 235 may comprise associating labels 119A-N with particular regions and/or pixels of the input image 355, may comprise generating a label mask corresponding to the input image 355, and/or the like.

In some embodiments, the CHC 110 further includes a scene labeling circuit 340 configured to associate scene labeling metadata with respective pixels and/or regions of the input image 355. The scene labeling module 340 may be configured label the input image 355 in accordance with the classification outputs 235 generated by the top-down classification module 230. In some embodiments, the scene labeling module 340 is configured to generate scene labeling metadata 241 for use in conjunction with the input image 355 (as opposed to creating a separate, labeled image 359, as disclosed herein). In one embodiment, the scene labeling metadata 241 comprises annotation metadata to identify labels 119A-N assigned to respective pixels and/or regions of the input image 355. The scene labeling metadata 241 may be displayed as annotations on the input image 355 on the display device 308. The scene labeling metadata 241 may include, but is not limited to: one or more image masks corresponding to labels 119A-N applied to the image (e.g., a mask to identify image regions assigned a particular label 119A-N); image annotation metadata adapted for use by particular image display and/or manipulation applications; an image filter to modify the appearance of particular regions of the input image 355, and/or the like.

The CHC 110 may further include an image display module 342 configured to display scene labeling metadata 241 on the display device 308. The image display module 342 may be configured to present the scene labeling metadata 241 in a graphical user interface on the display device 308. Displaying the scene labeling metadata 241 may comprise a) displaying the input image 355 on the display device 308 and b) displaying one or more annotations associated with the labels 119A-N assigned to the input image 308 on the display device 308. The display module 342 may be configured to display scene labeling metadata 241 on the display device 308 using any suitable display mechanism or technique including, but not limited to: overlaying graphical annotations on the input image 355 presented on the display device 308; displaying one or more image masks on the display device 308; providing one or more image masks to an image display application; filtering regions of the input image 355 presented on the display device 308; highlighting regions of the input image 355 presented on the display device 308; and/or the like. In some embodiments, the image display module 342 comprises an image display circuit and/or module configured to display image data (and annotations corresponding to the scene labeling metadata 241) on the display device 308. Alternatively, or in addition, the image display module 342 may be configured to display the input image 355 and annotations corresponding to the scene labeling metadata 241 by use of another imaging application (e.g., an dedicated image display and/or manipulation application).

In some embodiments, the scene labeling module 340 is configured to generate a labeled image 359, by use of an image manipulation module 344. The image manipulation module 344 may be configured to generate a labeled image 359 in response to an input image 355, classification outputs 235, and/or scene labeling metadata 241, as disclosed herein. Generating the labeled image 359 may comprise transforming the input image 355 to identify image regions and/or pixels associated with particular labels 119A-N, which may include, but is not limited to: applying one or more masks to the input image 355, filtering regions of the input image 355, highlighting regions of the input image 355, outlining regions of the input image 355, and/or the like.

In some embodiments, the post-classification policy 354 comprises scene labeling metadata to determine, inter alia, scene labeling operations of the CHC 110. The post-classification policy 354 may, for example, indicate that image regions associated with particular labels 119A-N should be prominently labeled (e.g., highlighted), and that image regions associated with other labels 119A-N may be ignored (and/or removed). In the FIG. 3B embodiment, the post-classification policy 354 may indicate that image regions that are associated with the background label 119A may be ignored (not labeled) or removed. The post-classification policy 354 may further indicate that image regions that are associated with label 119N (indicative of a potentially serious condition) are to be highlighted (e.g., prominently annotated). In response, the scene labeling module 340 may generate scene labeling metadata 241 configured to: a) ignore and/or remove background regions associated with label 119A from labeled images 359 (and/or other annotation metadata); and b) highlight regions associated with label 119A in labeled images 359 (and/or other annotation metadata). The CHC 110 may be further configured to display images comprising regions associated with label 119N on the display device 308 (with corresponding annotation metadata identifying the image region(s) associated with label 119N).

In the FIG. 3B embodiment, the classification application 350 implements an image classification operation on an input image 355 acquired by use of the image acquisition system 360 and/or other source. In response, the CHC 110 generates a classification output 235, by use of the bottom-up classification module 220 and/or top-down classification module 230, as disclosed herein. The classification application 350 may implement further additional operations pertaining to the input image 355 based on, inter alia, the classification output 235 and the post-classification policy 354. As illustrated in FIG. 3B, the classification output 235 may label image region 355[1] as background 119A, region 355[2] with label 119B, and region 355[3] with label 119N. The label 119N may be indicative of a potentially serious condition, such as malignant tumor. Accordingly, the post-classification policy 354 may be configured to issue one or more notifications and/or alerts in response to input images 355 having a region associated with the label 119B. The notifications and/or alerts may comprise one or more of: displaying an alert and/or notification on the display device 308, issuing an alert and/or notification on a network 306, and/or the like. The classification application 350 may be further configured to generate a labeled image 359 (by use of the scene labeling module 340 and/or image manipulation module 344, disclosed above). The labeled image 359 may comprise graphical annotations corresponding to the classifications output 235 (and in accordance with the post-classification policy 354). In the FIG. 3B embodiment, the post-classification policy 354 configures the CHC 110 to highlight regions having labels 119N and/or 119B to facilitate further review of the input image 355 (and/or perform further diagnosis by use of the input image 355 and/or corresponding label annotations). Input images 355 having different labels 119A-N may result in different post-classification operations 357A-N, as disclosed herein. Alternatively, or in addition, the classification application 350 may generate annotation metadata configured for display in conjunction with the input image 355, such as a label mask and/or the like, as disclosed herein.

In some embodiments, the classification application 350 is further configured to refine the CHC classification metadata 118 in response to image classification operations. After generating classification outputs 235 for an input image 355, an expert may reclassify the input image 355 (apply different labels and/or modify labeled regions within the input image 355). The relabeled image may be submitted to the CHC 110 through the training interface 113 to refine the parameters 114 of the bottom-up classification module 220 and/or top-down classification module 230, as disclosed herein. Alternatively, or in addition, the relabeled image may be incorporated into the training data 352 of the classification application 350 (e.g., as a training image 353A-N and ground truth comprising the modified labels 119A-N).

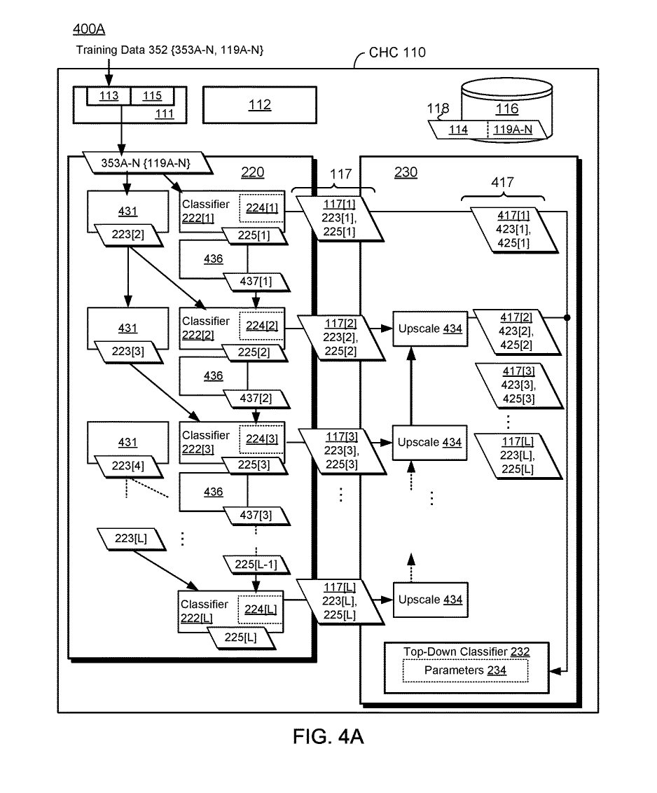

FIG. 4A is a schematic block diagram of another embodiment of a system 400A for scene labeling. The system 400A comprises a CHC 110 that includes a bottom-up classification module 220 and a top-down classification module 230, as disclosed herein. The CHC 110 may comprise a CHC interface 111 that includes a training interface 113 and a classification interface 115. The training interface 113 may be configured to receive training data 352 pertaining to particular image classification operations. As illustrated in FIG. 4A, the training data 352 may comprise a set of training images 353A-N having predefined classification metadata (e.g., labels 119A-N).

The bottom-up classification module 220 comprises a plurality of classifiers 222[1] configured to classify images at a particular resolution level within a hierarchy. The first classifier 222[1] may be configured to classify full-resolution image data (denoted 223[1]), the second classifier 222[2] may be configured to classify lower-resolution image data (image data processed through one downscaling operation, denoted 223[2]), the third classifier 222[3] may be configured to classify lower-resolution image data (image data downscaled through two downscaling operations, denoted 223[3]), and so on, to classifier 222[L] configured to classify lowest-resolution image data (image data downscaled through L-1 downscaling operations, denoted 223 [L]).

The bottom-up classification module 220 may be configured to train the classifiers 222[1]-222[L] by a) learning classification parameters 224[1] of the first classifier 222[1] by use of full-resolution training images 353A-N (and corresponding ground truth labels 119A-N); b) generating a classification output 225[1] of the first classifier 222[1]; c) for each of the remaining l classifiers (classifiers 222[2]-222[L]); d) downscaling the training images 353A-N through l downscale operations (by use of the downscale circuits 431); e) generating max-pooled classification outputs 437[l-1] corresponding to one or more lower-level classifiers 222[1]-222[L-1] (by use of respective downscale circuits 436); f) learning classifier parameters 224[l] by use of downscaled image data 223[l] and max-pooled classification outputs 437[l-1]; and g) generating classification outputs 225[l]. The classifiers 222[1]-222[L] may be configured to learn the classifier parameters 224[1]-224[L] in accordance with Eq. 1, and infer classification outputs in accordance with Eq. 2, as disclosed herein. The bottom-up classification module 220 may be configured to generate CCO metadata 117 comprising respective input image data 223[1]-223[L] and classification outputs 225[1]-225[L] of the classifiers 222[1]-222[L]. The downscale circuits 431 may correspond to a pixel averaging operator (e.g., average within a two by two pixel window), and the downscale circuits 436 may correspond to a max-pooling operator (e.g., maximum value within a two by two pixel window).

The top-down classification module 230 may incorporate the CCO metadata 117 to train the top-down classifier 232. The top-down classification module 230 may be configured generate upscaled classification metadata 417 that comprises classification outputs 225[1] and/or image data 223[1] of the first classifier and upscaled classification outputs 225[l] and/or image data 223 [l] of classifiers 222[2]-222[L] (denoted 425[1]-425[L] and 423[1]-423[L] in FIG. 4A). The top-down classification module 230 may learn parameters 234 of the top-down classifier 232 by use of the full-resolution training images 353A-N (e.g., image data 423[1]), upscaled classification outputs 425[1]-425[L], and respective upscaled image data 423[1]-423[L]. In some embodiments, the top-down classification module 230 learns parameters 234 in accordance with Eq. 3, as disclosed herein. The classification operations of the bottom-up classification module 220 and/or top-down classification module 230 may be managed by the coordination module 112, as disclosed herein. The coordination module 112 may be further configured to maintain CHC classification metadata 118 comprising the classifier parameters 114 learned and/or refined by use of the training data 352.

FIG. 4B is a schematic diagram of another embodiment of a system 400B for scene labeling. The system 400B comprises a CHC 110 that includes a bottom-up classification module 220 and a top-down classification module 230, as disclosed herein. The CHC 110 may comprise a CHC interface 111 that includes a classification interface 115. The CHC 100 of FIG. 4B may further include a scene labeling module 340, an image display module 342, and/or image manipulation module 344, as disclosed herein. The classification interface 115 may be configured to receive an input image 355 for classification by use of a particular set of CHC classification metadata 118. The input image 355 may have been acquired by use of an image acquisition system 360, as disclosed herein.

The input image 355 may be classified by use of the bottom-up classification module 220 and top-down classification module 230 (managed by the coordination module 112, as disclosed herein). The bottom-up classification module 220 comprises L classifiers 222[1]-222[L]. The bottom-up classification module 220 may be configured to determine classification outputs 225[1]-225[L] by: a) computing classification outputs 225[1] of the first classifier 222[1] using parameters 224[1] and the full-resolution input image 355 (denoted 223[1] in FIG. 4B); and b) for each of the l classifiers 2-L; c) computing classification outputs of classifier 222[l] using classifier parameters 224[l], downscaled image data 223[l ], and downscaled classification outputs of classifier 222[l-1] (classification outputs 225[l-1]). The downscaled image data 223[2]-223[L] and/or downscaled classification outputs 225[2]-225[L] may be generated by use of respective downscale circuits 431 and/or 436, as disclosed herein.

The bottom-up classification module 220 may provide the classification outputs 225[1]-225[L] to the top-down classification module 230 as CCO metadata 117. The CCO metadata 117 may further include and/or reference the downscaled image data 223 [2]-223 [L] used to derive the classification outputs 225[2]-225[L] (and/or the full-resolution input image 355/223[1] used to derive the classification outputs 225[1]).

The top-down classification module 230 may incorporate the CCO metadata 117 to generate a classification output 235. The top-down classification module may be configured to generate upscaled CCO metadata 417 comprising upscaled classification outputs 425[2]-425[L] and/or updated image data 423[2]-425[L] by use of respective upscale circuits 434, as disclosed herein. The top-down classifier 232 may label the input images 355 (generate classification outputs 235) by use of the input images 355, the upscaled CCO metadata 417, and the parameters 234. In some embodiments, the top-down classifier 232 infers the classification outputs 235 in accordance with Eq. 4, as disclosed herein. The CHC 110 may be further configured to identify and/or implement one or more post-classification operations 357A-N defined, inter alia, in a post-classification policy 354, as disclosed herein.

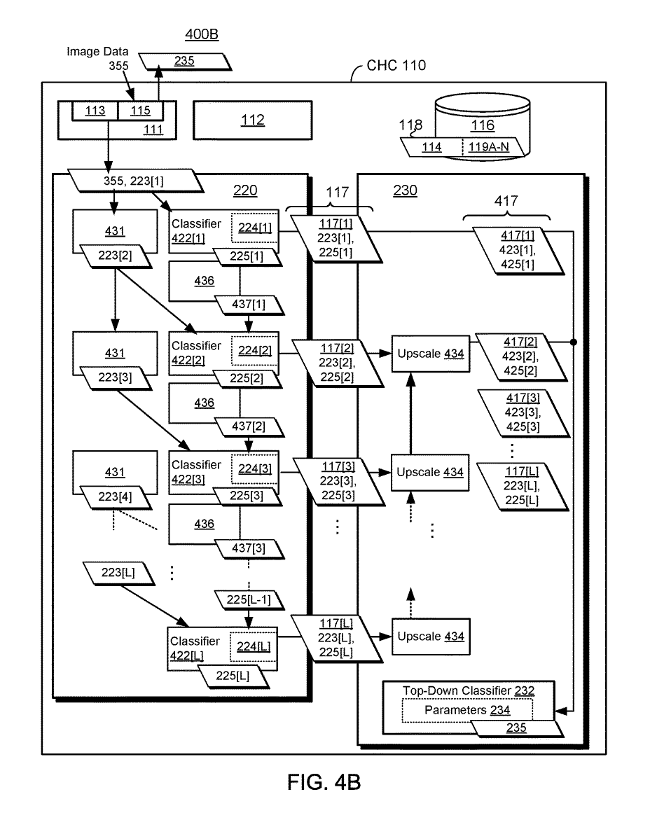

FIG. 5 is a flow diagram of one embodiment of a method 500 for training a scene labeler, such as the CHC 110, disclosed herein. Step 510 may comprise learning a first set of classifiers 122. Step 510 may be performed in response to receiving training data 352 through, inter alia, a training interface 113 of the CHC 110.

The first set of classifiers may comprise L hierarchical classifiers 222[1]-222[L] of a bottom-up classification module 220, as disclosed herein. Step 510 may comprise learning respective classifier parameters 234[1]-234[L], each corresponding to a respective one of L hierarchical classifiers 222[1]-222[L] by use of one or more training images 353A-N (and corresponding ground truths, such as predetermined labels 119A-N). The hierarchical classifiers 222[1]-222[L] may be configured to classify images of a particular type and/or resolution. In one embodiment, step 510 comprises training L classifiers 222[1]-222[L], including: classifier 222[1] configured to classify full-resolution image data; classifier 222[2] configured to classify lower-resolution image data (downscaled through a single downscaling operation); classifier 222[3] configured to classify lower-resolution image data (downscaled through two downscaling operations); through classifier 222[L] configured to classify lowest-resolution image data (downscaled through L-1 downscaling operations). Step 510 may further comprise inferring classification outputs 225[1]-225[L] of the respective classifiers 222[1]-222[L], and using outputs of lower-level classifiers (e.g., classification outputs 225[1]-225[L-1]) as inputs for learning parameters 234[2]-234[L] of higher-level classifiers 222[2]-222[L]. In one embodiment, step 510 comprises learning classifier parameters 234[1]-234[L] and/or inferring classification outputs 225[1]-225[L] in accordance with Eqs. 1 and 2 as disclosed herein.

Step 520 may comprise learning a second classifier by use of the first set of classifiers. Step 520 may comprise training a top-down classifier 232 by use of classification outputs 225[1]-225[L] of a bottom-up classification module 220. Step 520 may include determining classifier parameters 234 in accordance with Eq. 3, as disclosed herein. In some embodiments, step 520 further comprises selectively upscaling classification outputs 225[2]-225[L] and/or corresponding image data 223[2]-223[L] to a full-resolution scale (as described in conjunction with FIG. 4A).

Step 530 may comprise persisting classification metadata corresponding to the first set of classifiers and/or second set of classifiers. Step 530 may include maintaining CHC classification metadata 118, comprising classification parameters 114 and/or image labels 119A-N. The classification parameters 114 may include parameters 224[1]-224[L] of the bottom-up classification module 220 and/or parameters 234 of the top-down classification module 230. The labels 119A-N may comprise a label namespace for image classification operations of a particular type and/or pertaining to a particular image classification application 350. The labels 119A-N may correspond to predetermined labels 119A-N of the training images 353A-N used to learn the first set of classifiers and/or second classifier, as disclosed herein.

Step 530 may further comprise accessing the classification metadata to implement an image classification operation. Accessing the classification metadata may comprise retrieving CHC classification metadata 118 from classification metadata storage 116, and populating the first set of classifiers 122 and/or second classifier 132 with respective parameters and/or image classification labels 119A-N.

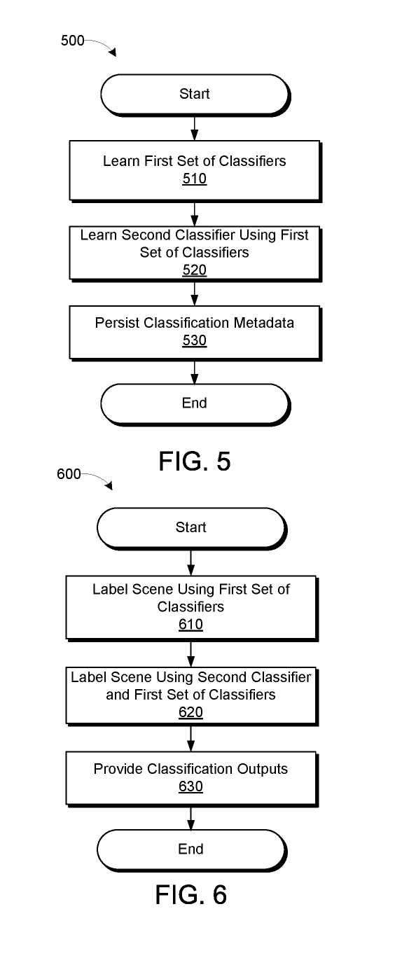

FIG. 6 is a flow diagram of another embodiment of a method 600 for scene labeling. Step 610 comprises inferring classification outputs of a first set of classifiers. Step 610 may comprise receiving a request to classify an input image 355 through, inter alia, a classification interface 115 of the CHC 110 and/or in response to training the CHC 110 by use of training data 352, as disclosed herein.

Step 610 may comprise labeling a scene by use of a first set of classifiers. Step 610 may comprise inferring classification outputs for the scene by use of a first set of classifiers 122. The first set of classifiers 122 may comprise L hierarchical classifiers 222[1]-222[L] of a bottom-up classification module 220. Step 610 may, therefore, comprise determining classification outputs 225[1]-225[L] for each of L hierarchical classifiers 222[1]-222[L] by use of respective classifier parameters 224[1]-224[L] and multi-resolution image data 223[1]-223[L]. Step 610 may further comprise accessing CHC classification metadata 118 comprising classification parameters 224[1]-224[L] of the L hierarchical classifiers 222[1]-222[L]. In some embodiments, the classification outputs 225[1]-225[L] of the first set of classifiers are inferred in accordance with Eq. 2, as disclosed herein.

Step 620 comprises labeling the scene using a second classifier and classification outputs 225[1]-225[L] of the first set of classifiers. Step 620 may comprise inferring classification outputs for the scene based on a) a full-resolution image of the scene, and b) classification outputs of the first set of classifiers (e.g., classification outputs 225[1]-225[L] of L hierarchical classifiers 222[1]-222[L]). Step 620 may further comprise upscaling classification outputs 225[2]-225[L] and/or corresponding image data 223[2]-223[L] of the classifiers 222[2]-222[L] to a full-resolution of scene. In one embodiment, step 620 comprises inferring classification outputs 235 in accordance with Eq. 4, as disclosed herein.

Step 630 comprises providing the classification outputs 235 of step 620. In some embodiments, step 630 further includes processing a post-classification policy 354, which may include implementing one or more post-classification operations 357A-N in accordance with labels 119A-N associated with the input image 355. The post-classification operations 357A-N, may include, but are not limited to: archiving the scene (e.g., input image 355) and/or classification outputs 235, transmitting the scene (e.g., input image 355) and/or classification outputs 235, generating classification metadata, such as a labeled scene (e.g., labeled image 359), displaying the scene and/or scene labels (e.g., classification outputs 235) on a display device 308, issuing one or more notifications and/or alerts pertaining to the classification outputs 235, and/or the like. Step 630 may further comprise generating scene labeling metadata 341 and/or a labeled image 359, as disclosed herein. Generating the labeled image 359 may comprise modifying the input image 355 to include annotations identifying regions of the input image 355 associated with particular labels 119A-N. Step 630 may further include displaying the input image 355, labeled image 359, and/or scene labeling metadata 341 on a display device 308, as disclosed herein.

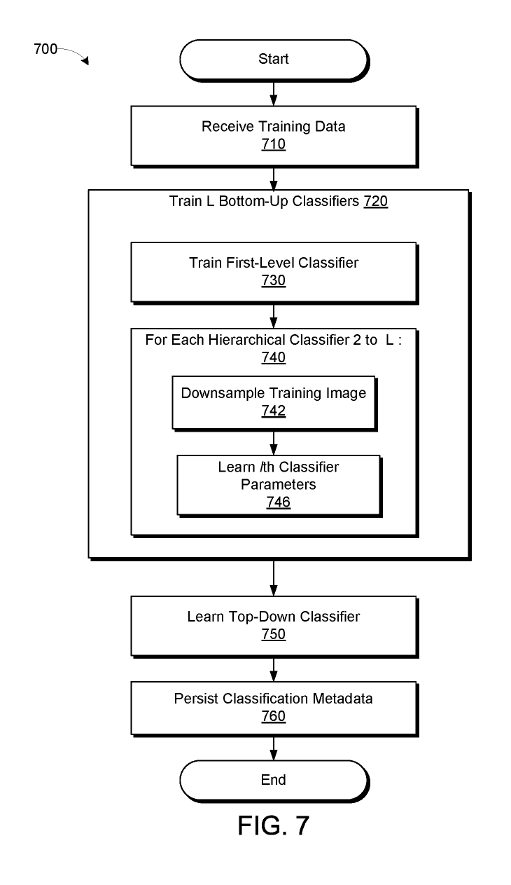

FIG. 7 is a flow diagram of another embodiment of a method 700 for training a scene labeler, such as the CHC 110, disclosed herein. Step 710 may comprise receiving training data 352 comprising one or more training images 353A-N and corresponding ground truths (e.g., predetermined labels 119A-N).

Step 720 may comprise training L bottom-up classifiers (e.g., classifiers 222[1]-222[L] of a bottom-up classification module 220). Training the L bottom-up classifiers may comprise training a first-level classifier 222[1] configured to classify full-resolution images at step 730 and training classifiers 222[2]-222[L] configured to classify lower-resolution images at step 740. Step 730 may comprise calculating classifier parameters 224[1] of the first-level classifier 222[1] based on a training image 353 (and predetermined labels 119A-N). In one embodiment, the classifier parameters 224[1] of the first-level classifier 222[1] are calculated in accordance with Eq. 1, as disclosed herein. Step 740 may comprise training L-1 hierarchical classifiers 222[2]-222[L] configured to classify lower-resolution images. Training a classifier 222[l] of hierarchical classifiers 222[2]-222[L] may comprise generating downscaled image data 223[l] by, inter alia, downscaling the training images 353A-N through l-1 downscaling operations (and/or downscaling the training images 353A-N l-1 times a scaling factor) at step 742 and learning classification parameters 224[l] of the hierarchical classifier 222[l] by use of the downscaled image data 223[l] and classification outputs 225[l-1] of one or more lower-level classifiers 222[1]-222[l-1]. In some embodiments, training the hierarchical classifier 222[l] further comprises generating downscaled classification outputs 437[l] by, inter alia, downscaling classification outputs 225[l-1] of hierarchical classifier 222[l-1]. In some embodiments, the classification parameters 224[l] may be learned in accordance with Eq. 1, as disclosed herein.

Step 750 may comprise learning classification parameters 234 of a top-down classifier by use of, inter alia, a full-resolution training images 353A-N (comprising ground truth labels 119A-N) and classification outputs 225[1]-225[L] of the bottom-up classifiers 222[1]-222[L]. In some embodiments, step 750 further includes upscaling classification outputs 225[2]-225[L] and/or corresponding image data 223[2]-223[L] to a full-resolution of the training images 353A-N, as disclosed herein. The parameters 234 of the top-down classifier 232 may be learned in accordance with Eq. 3, as disclosed herein.

Step 760 may comprise persisting classification metadata, comprising classification parameters 114 (e.g., classification parameters 224[1]-224[L] and/or 234), and corresponding labels 119A-N, as disclosed herein. Step 760 may further comprise accessing the classification metadata to classify one or more input images 355, as disclosed herein.

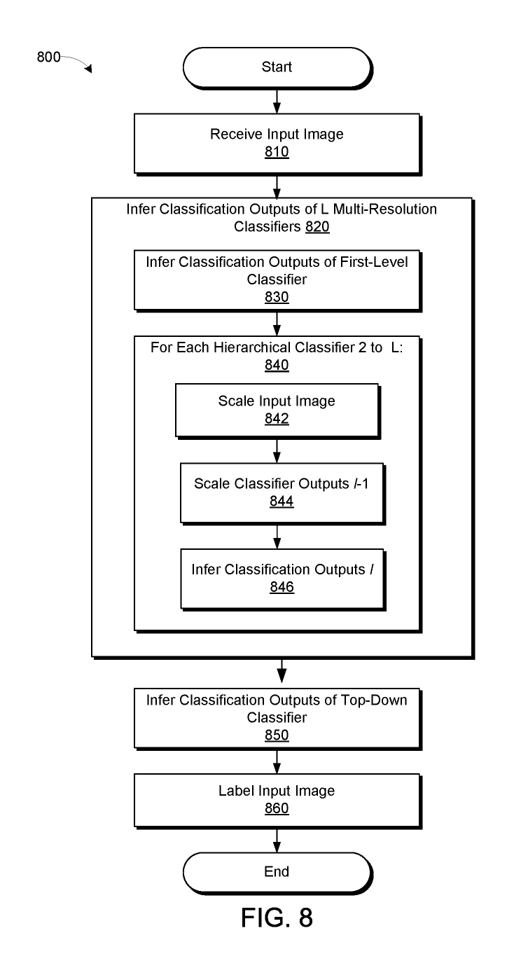

FIG. 8 is a flow diagram of another embodiment of a method 800 for scene labeling. Step 810 comprises receiving an input image 355. The input image 355 may have been acquired by use of an image acquisition system 360, as disclosed herein. Step 810 may comprise receiving the input image 355 through a classification interface 115 of the CHC 110, as disclosed herein. Step 810 may further comprise selecting CHC classification metadata 118 for use in classifying the input image 355, as disclosed herein.

Step 820 comprises labeling the input image 355 at each of L resolution levels of a bottom-up classifier. Step 820 may comprise inferring classification outputs 225[1]-225[L] corresponding to respective levels of a multi-resolution image hierarchy. Inferring the classification outputs 225[1] . . . 225[L] may comprise calculating classification outputs of a first-level classifier 222[1] based on a full-resolution input image 355 (image data 223[1]) at step 830 (e.g., in accordance with Eq. 2, as disclosed herein). Inferring classification outputs 225[2]-225[L] may comprise iteratively calculating classification outputs of L-1 classifiers at step 840. Inferring a classification output 225 [l] generating downscaled image data 223 [l] by, inter alia, downscaling the input image 355 through l-1 downscaling operations (and/or downscaling the input image 355 by l-1 times a scaling factor) at step 842; generating downscaled classification outputs 437[l-1] corresponding to a previous level in the hierarchy (e.g., by downscaling classification outputs 225[l-1] at step 844); and inferring classification outputs 225[l] of the classifier 222[i]by use of the classifier parameters 224[l], the downscaled image data 223[l], and the downscaled classification outputs 437[l-1] (e.g., in accordance with Eq. 2, as disclosed herein).

Step 850 comprises inferring classification outputs 235 of a top-down classifier 232. Step 850 may comprise inferring the classification outputs 235 by use of, inter alia, the full-resolution input image 355, classification outputs 225[1]-225[L] of the bottom-up classifiers 222[1]-222[L] and/or scaled image data corresponding to the classification outputs 225[2]-225[L]. In some embodiments, step 850 further includes upscaling the classification outputs 225[2]-225[L] and/or corresponding image data 223[2]-223[L] to a full-resolution of the training images 353A-N, as disclosed herein (e.g., generating upscaled CCO metadata 417 as disclosed above in conjunction with FIG. 4B). The classification outputs 235 of step 850 may be inferred in accordance with Eq. 4, as disclosed herein.

Step 860 may comprise labeling the input image 355 with the classification outputs of step 850 (e.g., classification outputs 235). Step 860 may comprise returning the classification outputs 235 through the classification interface 115 (e.g., to the classification application 350, as disclosed above). Alternatively, or in addition, step 860 may comprise annotating the input image 355 to identify labeled regions and/or pixels within the input image 355 (e.g., by use of a label mask, an overlay, an image metadata, and/or the like). Step 860 may further comprise implementing post-classification operations 357A-N in accordance with a post-classification policy 354, as disclosed herein.

Embodiments may include various steps, which may be embodied in machine-executable instructions to be executed by a computer system. A computer system includes one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD ROMs, DVD ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Each computer system includes at least a processor and a memory; computer systems may also include various input devices and/or output devices. The processor may include a general-purpose device, such as an Intel®, AMD®, or other “off-the-shelf” microprocessor. The processor may include a special-purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer executable code located within a memory device. A software module may, for instance, include one or more physical or logical blocks of computer instructions, which may be organized as a routine, program, object, component, data structure, etc., that perform one or more tasks or implement particular abstract data types.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general-purpose computers; computer programming tools and techniques; computer networks and networking technologies; digital storage media; authentication; access control; and other security tools and techniques provided by public keys, encryption, firewalls, and/or other means.

A subsystem may include a processor, a software module stored in a memory and configured to operate on the processor, a communication interface, sensors, user interface components, and/or the like. The components in each subsystem may depend on the particular embodiment (e.g., whether the system directly measures data or acquires the data from a third party). It will be apparent to those of skill in the art how to configure the subsystems consistent with the embodiments disclosed herein.

We claim:

1. An apparatus, comprising:
an image classifier comprising a bottom-up classification circuit and a top-down classification circuit;
wherein the bottom-up classification circuit is configured to train L hierarchical classifiers, wherein each of the L hierarchical classifiers corresponds to a respective image resolution level, the L hierarchical classifiers comprising a highest-resolution classifier and one or more lower-resolution classifiers,
wherein the bottom-up classification circuit is configured to determine parameters of the highest-resolution classifier by use of a training image, and
wherein the bottom-up classification circuit is configured to determine parameters of the one or more lower-resolution classifiers based on downscaled versions of the training image and classification outputs of one or more higher-resolution classifiers;
wherein the top-down classification circuit is configured to train a top-down classifier by use of the full-resolution training image and classification outputs corresponding to each of the L classifiers of the bottom-up classification circuit; and
wherein the image classifier is configured to classify an input image by use of the L classifiers of the bottom-up classification circuit and the top-down classifier of the top-down classification circuit.

2. The apparatus of claim 1, further comprising a scene labeling module to annotate the input image in accordance with a classification output of the top-down classification circuit.

3. The apparatus of claim 1, further comprising an image manipulation module to derive a labeled image in response to the input image, wherein the labeled image comprises one or more regions of the input image corresponding to one or more classification labels of a classification output of the top-down classification circuit.

4. The apparatus of claim 1, wherein training a lower-resolution hierarchical classifier l of the L hierarchical classifiers comprises producing a downscaled version of the training image, generating downscaled classification outputs corresponding to classification outputs of hierarchical classifier l-1, and learning parameters of the lower-resolution classifier l by use of the downscaled version of the training image and the downscaled classification outputs.

5. The apparatus of claim 4, wherein the bottom-up classification circuit calculates the parameters of the lower-resolution classifier l to maximize a probability of classifying the downscaled version of the training image in accordance with the downscaled classification outputs.

6. The apparatus of claim 4, wherein the bottom-up training circuit determines parameters \hat{θ}ₗ of the classifier l by
$$\hat{{θ}_{l}} = {arg max}_{{θ}_{l}} P ( Γ ( Y , l - 1 ) \vert Φ ( X , l - 1 ) , Γ ( {\hat{Y}}^{1} , l - 1 ) - Γ ( {\hat{Y}}^{l - 1} , 1 ) ; {θ}_{1} )$$
wherein Γ is a max-pooling operator, Φ is an image downscaling operator, and Ŷ corresponds to classification outputs of other hierarchical classifiers.

7. The apparatus of claim 6, wherein the top-down training circuit determines parameters \hat{β} of the top-down classifier by
$$\hat{β} = {arg max}_{β} P ( Y \vert X , {\hat{Y}}^{1} , Ω ( {\hat{Y}}^{2} , 1 ) - Ω ( {\hat{Y}}^{L} , L - 1 ) ; β ) .$$
wherein Ω is an image upscaling operator, and Y is a ground truth of the training image.

8. The apparatus of claim 7, wherein the image classifier circuit determines classification outputs Ŷ of the respective L hierarchical classifiers in response to an input image Q by:
$${\hat{Y}}^{l} = {arg max}_{Y} P ( Y \vert Φ ( Q l - 1 ) , Γ ( {\hat{Y}}^{- 1} , l - 1 ) - Γ ( {\hat{Y}}^{l - 1} , 1 ) ; \hat{{θ}_{l}} ) ,$$
wherein the image classifier determines classification outputs \hat{Z} of the top-down classifier by:
$$\hat{Z} = {arg max}_{Y} P ( Y \vert Q , {\hat{Y}}^{1} , Ω ( {\hat{Y}}^{2} , 1 ) - Ω ( {\hat{Y}}^{L} , L - 1 ) ; \hat{β} ) .$$

9. A system, comprising:
an image classification device comprising a first classification module that trains L resolution-specific classifiers by use of a set of training images, the L bottom-up classifiers comprising a first, full image resolution bottom-up classifier and bottom-up classifiers 2 through L corresponding to lower image resolutions,
wherein training the first bottom-up classifier comprises learning classifier parameters using the set of training images, and
wherein training bottom-up classifier 1 of bottom-up classifiers 2 through L on a training image X of the set of training images comprises determining classifier parameters \hat{θ}ₗ of the bottom-up classifier l by
$$\hat{{θ}_{l}} = {arg max}_{{θ}_{l}} P ( Γ ( Y , l - 1 ) \vert Φ ( X , l - 1 ) , Γ ( {\hat{Y}}^{1} , l - 1 ) - Γ ( {\hat{Y}}^{l - 1} , 1 ) ; {θ}_{l} )$$
wherein Γ and Φ are downscaling operators, and Y are classification outputs of bottom-up classifiers 1 through l-1;
the image classification device further comprising a second classification module that determines parameters \hat{β} of a composite-resolution classifier by use of the set of training images and classification outputs Ŷ of the L resolution-specific classifiers by
$$\hat{β} = {arg max}_{β} P ( Y \vert X , \hat{{Y}^{1}} , Ω ( {\hat{Y}}^{2} , 1 ) - Ω ( {\hat{Y}}^{L} , L - 1 ) ; β )$$
wherein Ω is an upscaling operator; and
a display module that displays label annotations on a display device corresponding to classification outputs for an input image generated by use of the L resolution-specific classifiers and the composite-resolution classifier.

10. The system of claim 9, wherein the composite-resolution classifier infers classification outputs \hat{Z} of the input image Q by use of classification outputs of the L bottom-up classifiers Ŷ and the parameters \hat{β} by
$$\hat{Z} = {arg max}_{Y} P ( Y \vert Q , {\hat{Y}}^{1} , Ω ( {\hat{Y}}^{2} , 1 ) - Ω ( {\hat{Y}}^{L} , L - 1 ) ; \hat{β} ) .$$

11. The system of claim 9, further comprising an image transformation module that applies classification labels to the input image in accordance with the classification output \hat{Z}.

12. The system of claim 9, wherein the L resolution-specific classifiers comprise logistic disjunctive normal network classifiers.

13. The system of claim 9, further comprising post-classification policy that defines one or more post-classification processing operations to implement in response to an input image comprising a region associated with a particular label.

14. A method, comprising:
training a plurality of intermediate classifiers, each intermediate classifier corresponding to a respective image resolution, wherein training the intermediate classifiers comprises:
training a high-resolution intermediate classifier by use of a training image, and
training one or more lower-resolution intermediate classifiers by use of lower-resolution versions of the training image and outputs of one or more higher-resolution intermediate classifiers;
training a multi-resolution image classifier by use of classification outputs of the plurality of intermediate classifiers; and
transforming an input image by labeling regions of the input image according to classification outputs of the multi-resolution image classifier and the plurality of intermediate classifiers.

15. The method of claim 14, wherein transforming the input image comprises annotating a region of the input image that is associated with a particular classification label.

16. The method of claim 14, wherein transforming the input image comprises graphically depicting labeled regions of the input image on a display device in accordance with the classification outputs of the multi-resolution image classifier.

17. The method of claim 14, wherein training the high-resolution intermediate classifier comprises calculating parameters for the high-resolution intermediate classifier that maximize a probability of labeling regions of the training image in accordance with predetermined labels of the training image, and
wherein training a lower-resolution intermediate classifier comprises calculating parameters for the lower-resolution intermediate classifier that maximize a probability of labeling regions of a lower-resolution version of the training image in accordance with a classification output of the high-resolution intermediate classifier.

18. The method of claim 14, wherein training the multi-resolution classifier comprises determining classifier parameters that maximize a probability of correct classification of the training image in accordance with classification outputs of the plurality of intermediate classifiers.

19. The method of claim 14, wherein training the plurality of intermediate classifiers comprises:
determining parameters [symbol] of a first intermediate classifier using the training image X having predetermined labels Y; and
calculating parameters \hat{θ}ₗ of intermediate classifiers at l resolution levels by:
$$\hat{{θ}_{l}} = {arg max}_{{θ}_{l}} P ( Γ ( Y , l - 1 ) \vert Φ ( X , l - 1 ) , Γ ( {\hat{Y}}^{1} , l - 1 ) - Γ ( {\hat{Y}}^{l - 1} , 1 ) ; {θ}_{l} )$$
wherein Γ and Φ are downscaling operators, and Ŷ are outputs of respective intermediate classifiers.

20. The method of claim 19, further comprising calculating parameters \hat{β} of the multi-resolution classifier by use of classification outputs of the first intermediate classifier, and the l lower-resolution classifiers by
$$\hat{β} = {arg max}_{β} P ( Y \vert X , {\hat{Y}}^{1} , Ω ( {\hat{Y}}^{2} , 1 ) - Ω ( {\hat{Y}}^{L} , L - 1 ) ; β ) ,$$
wherein Ω is an up-sampling operator.
